(19) United States
(12) Patent Application Publication
(10) Pub. No.: US 2025/0171004 A1
(43) Pub. Date: May 29, 2025

(54) Park Brake Caliper With Inverted Lever Configuration

(71) Applicant: KNORR-BREMSE SYSTEME FÜR NUTZFAHRZEUGE GMBH, München (DE)

(72) Inventors: Ekaterina LISEVA, Muenchen (DE); Michael BLESSING, Muenchen (DE); Matthias KLINGNER, Emmering (DE); Michael PESCHEL, Schoengeising (DE); Zsombor GYOERKE, Keszthely (HU); Csaba MLINARCSEK, Budapest (HU); Sebastian SCHALLER, Langweid (DE); Dordo STANKOVIC, Muenchen (DE); Janos SZABO, Budapest (HU); Csaba KOKREHEL, Budapest (HU); Levente HOES, Budapest (HU); Gyula MONORI, Lakitelek (HU); Sven Philip KRUEGER, Muenchen (DE); Tobias SCHOEFBERGER, Mainburg (DE); Korbinian HEIGL, Pliening (DE); Daniel GEIS-ESSER, Muenchen (DE)

(21) Appl. No.: 18/833,494

(22) PCT Filed: Dec. 27, 2022
(86) PCT No.: PCT/EP2022/087887

§ 371 Date: Jul. 26, 2024

(30) Foreign Application Priority Data
Jan. 28, 2022 (EP) 22154054.5

(51) Int. Cl. B60T 13/38; B60T 1/06; B60T 13/22; B60T 13/58; B60T 13/74; F16D 55/2255; F16D 65/095; F16D 65/18; F16D 121/06; F16D 121/22

(52) U.S. Cl. CPC B60T 13/38; B60T 1/065; B60T 13/22; B60T 13/58; B60T 13/743; F16D 55/2255; F16D 65/095; F16D 65/18; F16D 2121/06; F16D 2121/22

(57) ABSTRACT

A park brake caliper for a utility vehicle has an actuating unit, which is adapted to move a push rod, wherein the push rod is pre-tensioned by a tensioning device in one direction, but is adapted to be pressed in the opposite direction by a pneumatic, hydraulic, electromechanical or magnetic force, and an application unit which includes a brake lever, which is pivotably supported around a pivot axis and which is adapted to rest at the push rod at one side and at a bridge on the other side via an excenter. The application unit is adapted to be positioned around an axle of a utility vehicle. The bridge is adapted to press at least one brake pad against a brake disc of the utility vehicle. The lever points downwards towards the axle in all of its positions. A brake system is disclosed, where the park brake caliper and a service brake caliper are radially spaced from each other.

### BACKGROUND AND SUMMARY

Brake systems for commercial vehicles or utility vehicles typically include a park brake and a service brake. Usually, the park brake and the service brake are arranged in one caliper.

A typical brake caliper includes an actuating unit, which generates the brake force, and an application unit, which forces friction material into contact with a brake disc or a brake drum assembly. A service brake actuator normally actuates a brake under the normal driving conditions, and a park brake actuator (e.g. containing a compressed spring in a released state) is used for actuating the brakes when power is removed and the vehicle stands still.

An application unit arranged in a brake caliper is designed to accommodate the application of the input force at a certain angle to the axis of operation of the application unit, and normally includes a force multiplier (e.g., a lever with bearing surfaces).

Document DE 10 2013 100 173 A1 describes a disc brake for a utility vehicle. It discloses a caliper with a pivotable braking lever designed with an excenter, which rests at the caliper and a bridge part. A brake pad is connected to the bridge part. During parking of the vehicle, a spring forces the lever into a position where it presses the bridge in the direction of the brake pads, and the brake pads press against the brake disc. In a released condition, the lever is not forced against the bridge part, and hence, pads are not forced against the brake disc.

Usually, an application unit with a pivotable brake lever requires enough space for accommodating its functional parts (in particular brake lever and bridge) in the caliper, and regularly, the actuation unit is disposed in the upper part of the application unit and sometimes even points upwards (i.e. away from the axle when mounted in a 12 o'clock position), as also being the case in document DE 10 2013 100 173 A1. A flange is regularly used for connecting the application unit and the actuation unit, being provided either along a substantially parallel axis with respect to the application unit or being mounted at an angle of 90° with respect to the application unit, e.g. the middle axis of the application unit.

Because of the electrification in commercial vehicles, axial space is sometimes not present close to knuckles, and hence, actual space savings are very important, in particular in view of driveline and battery packaging.

A conventional park brake cylinder, which usually is part of a combined brake cylinder used for both service and parking brake functions, takes up a lot of valuable axial space.

For passenger cars, a splitting of the calipers has already been performed, wherein separate calipers for the park brake and for the service brake are provided.

A combined service and parking brake, particularly in the case of actuators comprising a service chamber and a parking chamber, is difficult to be positioned in 3 o′clock-position or 9 o'clock position at the front axis of a commercial vehicle due to the axial length of the combined cylinder which will collide with other axial components, once integrated there, or due to the steering angle, which might play a role. This in particular is true for novel wheel-individual suspensions with high steering angles and a knuckle design that does not allow the conventional 12 o'clock-position of a combined brake actuator.

In electric vehicles, a compact drive train design freeing up space for batteries, fuel cell components, and lock brake modulators, etc. is needed, to achieve higher drive train efficiencies or a wheel-individual drive. High drivetrain power is needed for heavy-duty applications, leading to significantly increased lateral space demand in-between the wheels of the driven axle.

However, the axial length of the park brake actuator is often larger than the service brake actuators. If they are combined at one caliper, the needs for realization of electric drives cannot be met due to spatial shortage at the axle.

A technical problem of the present invention can hence be seen in providing a spatially optimized brake arrangement for use in commercial vehicles, in particular in seeking for axial length reduction of the brake system.

The technical problem is solved by a park brake caliper and a brake system according to the independent claim(s). Further advantages and embodiments of the present invention are the subject matter of the dependent claims.

A park brake caliper according to the present application comprises an actuation unit, which is adapted to move a push rod. The push rod adapted to be pressed in one direction, but can be pressed in the opposite direction by energy supply.

The application unit comprises a brake lever, which is pivotably supported around a pivot axis and which is adapted to rest at the push rod at one side and at the bridge on the other side via an excenter.

The application unit is adapted to be positioned around an axle of a utility vehicle, and the bridge is adapted to press at least one brake pad against the brake disc of a utility vehicle. The lever points towards the axle in all its positions.

Towards to axle means pointing somehow to the axle-but does not necessarily mean it has to strictly follow the gravitational direction in this case. In the prior art, the lever points in the direction away from the axle. The term pointing refers to the extension of the long part of the lever, considered in relation to the pivot point or the pivoting axis.

Hence, a park brake actuator can be positioned independently from any service brake actuator, hence reducing the actual length of the park brake actuator, as no combined actuator (together with a service brake) is used.

The bridge and the maximum radial lever position are designed to be within the allowable radial placement within a given rim, by realizing an inverted actuator lever arm placement with an inverted pivot axis. Hence, a larger part of the caliper can at least be partly arranged within the wheel rim.

Preferably, the push rod is pre-tensioned, further preferably by a spring, in one direction in order to force the bridge to press at least one brake pad against a brake disc of the utility vehicle, but is adapted to be pressed in the opposite direction by a pneumatic, hydraulic, electromechanical or magnetic force (in order to release the brake), if said pneumatic, hydraulic, electromechanical or magnetic force is higher than the force generated by the pre-tensioning member, e.g. spring. The push rod could also be pre-tensioned by other components, e.g. clutches.

Preferably, the axis of motion of the push rod of the actuating unit and the axle including an angle between 10° and 80°, more preferably between 15° and 75°, even more preferably between 20° and 75°, and even more preferably between 45° and 75°.

By arranging the actuating unit in said angle allows a compact design of the caliper, as the actuating unit is connected to the application unit in a way that space can be saved, as the actuation unit points in an oblique direction (e. g. upwards).

Preferably, the park brake caliper further contains a second push rod accommodated in an additional chamber (e.g. pneumatic chamber or chamber accommodating hydraulic, magnetic or electromechanical components), said second push rod being adapted to transmit forces to the brake lever on the opposite side of the brake lever compared to the first push rod. The additional chamber is further preferably positioned on the opposite side of the brake lever compared to the first push rod and preferably the spring. In this embodiment, the actuating unit is split into two parts, disposed on opposite sides of the lever and the application unit. Hence, the additional chamber or the spring assembly can be positioned at least partially inside the wheel rim, hence further reducing the axial space for the park brake caliper.

Preferably, the middle axis of the bridge has a smaller distance from the axle than the pivoting axis of the lever.

By such configuration, the transmission of forces is optimized. Further a common spring chamber can be used, e.g. a push type design. Further, a common emergency release design (e. g. with the help of a screw) can be easily implemented, as such emergency release screw is easily accessible in this case.

More preferably, the joint between the push rod and the lever or the instantaneous center for rotation of the push rod and the lever has a smaller distance to the axle compared to the bridge plane. In other words: All kinematic parts are below the bridge plane, preferably at least the lever, the push rod and the spring.

Also this design allows a compact arrangement of all kinematic parts and further an optimized transmission of forces.

In this embodiment, the push rod is pushed against the lever.

In another embodiment, the middle axis of the bridge has a larger distance from the pivoting axis of the lever.

In that embodiment, the force of the spring pulls the rod (in this case: a pull rod) and the lever, hence forming a pull-connection.

The caliper in this case can contain less parts above the bridge plane, and the rod (here a pull rod) could be designed thinner, as there is no danger of a buckling problem. Furthermore, the caliper could be designed in a more flat manner. Further the inverted positioning of the additional chamber and spring part leads to a better pneumatic piping accessibility.

Preferably, the actuating unit has a housing, and the application unit also has a housing. Then, the actuating unit is connected to the application unit by a flange, and more preferably at least a part of the flange, even more preferably the whole flange, is positioned below the bridge plane.

The arrangement of actuating unit and application unit in separate housings also allows a very compact design, and these parts can be fabricated independently from each other, and also can be changed at a vehicle with less work. The flange lying below the bridge plane also allows an improved transmission of forces. Modularity and scalability is enabled by combining one type of application unit with different types of actuation units. This further enhances realizing a parking brake torque adaptation as required depending on vehicle class or axle application (a front axle requires usually lower parking brake torque than a rear axle).

Preferably, the actuating unit and the application unit are disposed in a common housing.

Hence, the actuation system, e.g. pneumatic system, can be assembled with a brake, and no separate flange is necessary, being the reason why this solution saves costs.

Further, a reduction of weight of the caliper is enabled, because of a function integration of parts—e.g. no flange and connection screws are needed. A low weight is always beneficial for brake parts, because they count to the unsprung mass of a wheel end. It should be emphasized that the actuation can also be performed via a hydraulic, magnetic or an electromechanical system,

More preferably, the plunger and the lever are integrally formed in one combined member. Also, this design allows using of less parts, facilitating the mounting of the park brake caliper.

Preferably, the surface of the application unit, in particular of its housing, is flat or slightly curved, but the curve would be parallel to the curve of the wheel rim.

A hump is more preferably provided in the uppermost surface of the application unit in order to stabilize the whole system by adding stiffness to the caliper.

The caliper can be of a floating type.

A (one) carrier (for the brake pads) can be used—but also, the brake pads can be mounted to the caliper directly, hence not necessitating a carrier.

A brake system according to the present invention comprises a park brake caliper as described before, and a service brake caliper. Both can have separated actuators. The friction pairings (brake pads) of the park brake caliper and the service brake caliper are radially spaced from each other, i.e. are positioned at radially different positions on a brake disc. Preferably, also the park brake caliper and the service brake caliper are radially separated.

Hence, the axial length of the brake system can be reduced, as both calipers are radially separated and do not interfere with each other.

Even more preferably, the friction pairing between the park brake pads and brake disc has a larger friction radius than the friction pairing between service brake pads and brake disc.

Hence, the park brake can achieve a higher park brake torque at a given clamping force, and hence, the park brake can also be used as a booster for the service brake.

More preferably, the brake pads of the park brake and the brake pads of the service brake are guided by a respective carrier, wherein the carriers are preferably connected.

For the case of separate carriers, there is more flexibility for the placement of the service brake and the park brake around the rim. For the case of a common (connected) carrier, there are cost/weight savings, since only one connection to the wheel hub is needed.

In the following, embodiments of the present application are described with the attached figures.

### BRIEF DESCRIPTION OF THE DRAWINGS

FIG. 1 is a schematic view of a park brake caliper 1 according to a first embodiment of the present invention.

FIG. 2 is a schematic view of a park brake caliper 1 according to a second embodiment of the present invention.

FIG. 3 is a schematic view of a park brake caliper 1 according to a third embodiment of the present invention.

FIG. 4 is a schematic view of a park brake caliper 1 according to a fourth embodiment of the present invention.

FIG. 5 is a schematic view of a park brake caliper 1 according to a fifth embodiment of the present invention.

FIG. 6 is a schematic view of a park brake caliper 1 according to a sixth embodiment of the present invention.

FIG. 7 is a schematic view of a park brake caliper 1 according to a seventh embodiment of the present invention.

FIG. 8 shows arrangements of a park brake caliper 1 and a service brake caliper S on a brake disc D.

### DETAILED DESCRIPTION OF THE DRAWINGS

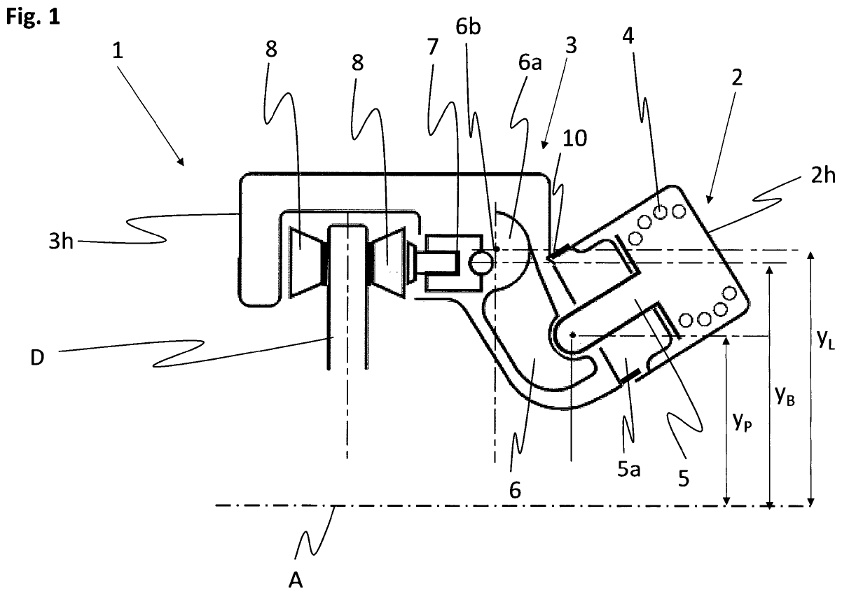

It should be emphasized that FIGS. 1 to 8 are schematical drawings. Of course, housings need to provide sufficient space so that the lever can make a movement which is suitable to perform the braking/releasing action.

FIG. 1 shows a brake caliper 1 according to a first embodiment of the present invention.

An application unit 3 (with a housing 3h) engages over a brake disc D connected to an axle A. Brake pads 8 are arranged at both sides of the brake disc D. At one side, a respective brake pad 8 is connected to a bridge 7. A lever 6 on its upper side rests against the bridge 7 via an excenter 6a, and is pivotably supported around a pivot axis 6b. On the other side, the lever 6 rests against a push rod 5, which belongs to an actuation unit 2 (with a housing 2h), which is connected to the application unit 3 via a flange 10. The push rod 5 is pressed by a spring 4 in the direction of the lever 6; however, a chamber 5a, in this case pneumatic chamber, is positioned between the spring 4 and the flange 10, and if pneumatic pressure is applied to the chamber 5a, the force of the spring 4 can be overcome and the push rod 5 can be pressed against the force of the spring 4, hence releasing the lever 6, which would lead to a situation that the brake pads 8 are not forced against the brake disc D. Herein, the distance between the pivot axis 6b of the lever 6 and the axle A is larger than the distance between the middle axis of the bridge 7 and the axle A. Even smaller is the distance between the lowest part of the push rod 5 and the axle A.

In all states, the lever 6 points towards the axle, i.e. in the direction of the axle A (in the embodiment of FIG. 1 downwards, as the caliper 1 is arranged in the 12 o'clock-mounting position). That does not mean that the lever 6 strictly is aligned along the gravitational direction-but it points towards the axle A. In other words: The angle the gravitational direction and the middle axis of the lever 6 include, is less than 90°.

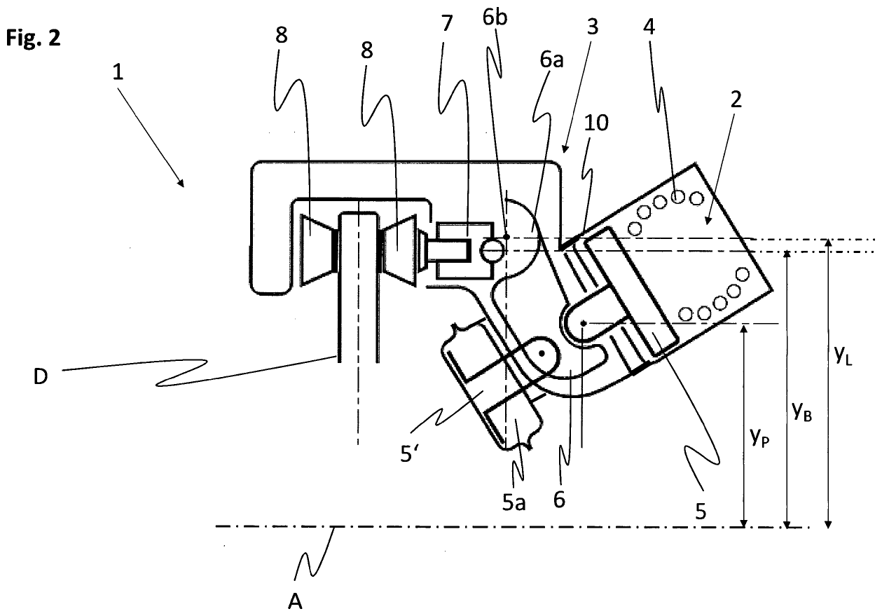

FIG. 2 shows a second embodiment of the present invention. This embodiment is similar to the first embodiment, however, there is a second push rod 5′ which can be actuated by an additional chamber 5a, in this case a pneumatic chamber. However, said additional chamber 5a is positioned on the other side of the actuation unit 3, hence, the first push rod 5 can press the lever 6 in one direction by the force of the spring 4, but if the additional chamber 5a is actuated, the second push rod 5′ is adapted to push the lever 6 in the opposite direction. Again, in all states, the lever 6 points downwards, i.e. in the direction of the axle A.

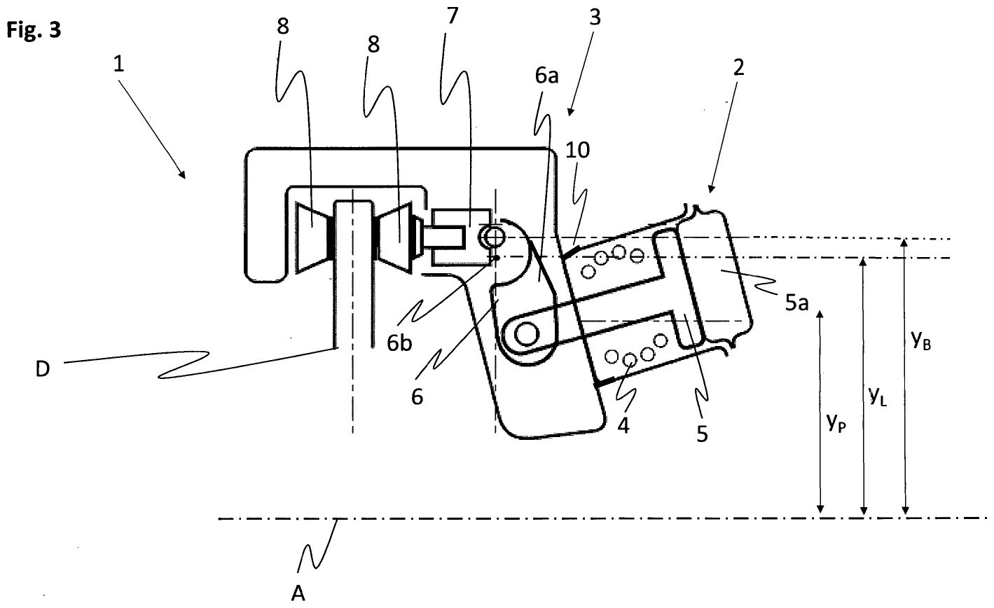

FIG. 3 shows a third embodiment of the present application. Herein, the difference is that the distance between the middle axis of the bridge 7 and the axle A is larger than the distance between the pivoting axis 6b of the lever 6 and the axle A. Also, the arrangement of the spring 4 and the chamber 5a with regard to the push rod 5 has been changed compared to the first embodiment (FIG. 1). Herein, the spring 4 pushes the push rod 5 in the direction away from the lever 6, leading to a state that the lever 6 is pulled, but pushes the bridge 7 against one of the brake pads 8, hence actuating the park brake. Upon pressurization of the chamber 5a (in this case: pneumatic chamber), the force of the spring 4 can be overcome, hence pushing the push rod 5 in the direction of the lever 6, leading to the state that the bridge 7 can move in the direction away from the one brake pad 8, hence leading to a released state of the brake. Herein, the flange 10 being adapted to connect the actuating unit 2 and the application unit 3 is at least partly below the bridge plane, being a plane parallel to the axle A and including the middle axis of the bridge 7.

However, if the force of the spring 4 is dominant over the force of the chamber 5a (in this case: pneumatic chamber), the push rod is forced in a direction so that it pulls the lever 6, hence pushing the bridge 7 against the brake pad 8, which again is pushed against the brake disc D.

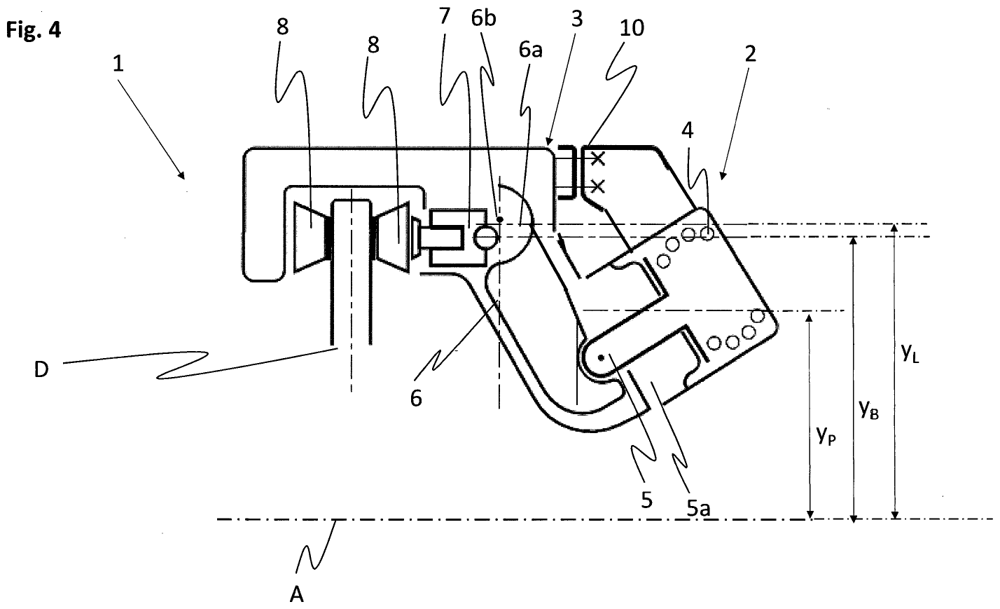

FIG. 4 shows a fourth embodiment of the present invention. Herein, the flange 10 being adapted to connect the actuating unit 2 and the application unit 3 is realized differently, and the flange is provided on the side part of the actuation unit 2. Herein, the flange 10 is positioned above the bridge plane, being a plane parallel to the axle A and including the middle axis of the bridge 7.

Herein, packaging or accessibility of the flange connection can be improved, and still, a compact design can be achieved.

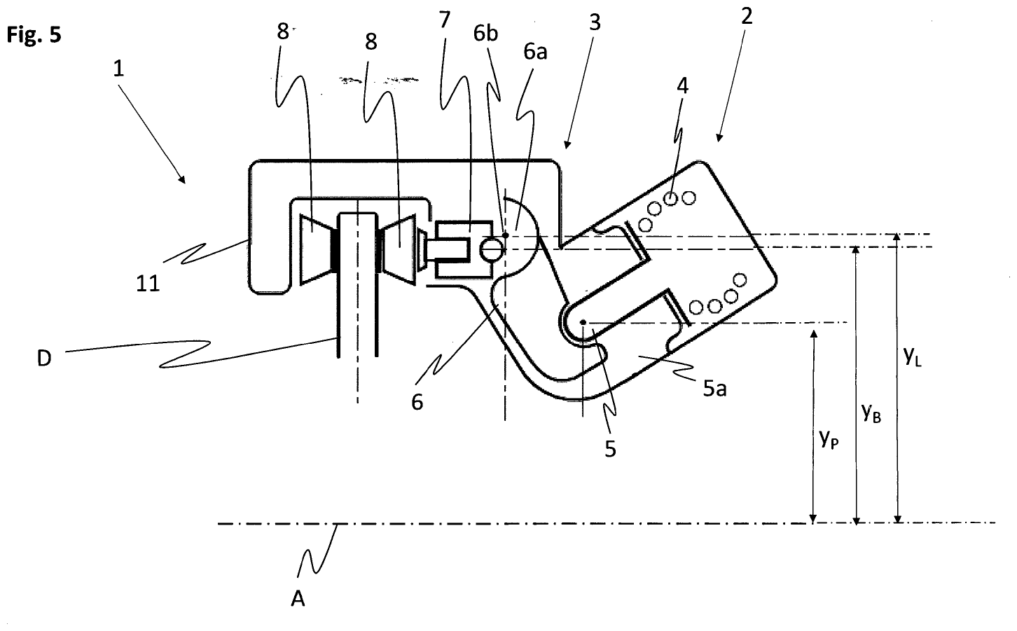

FIG. 5 shows an embodiment where the actuation unit 2 and the application unit 3 are disposed in a common housing 11. Hence, no flange is necessary any more.

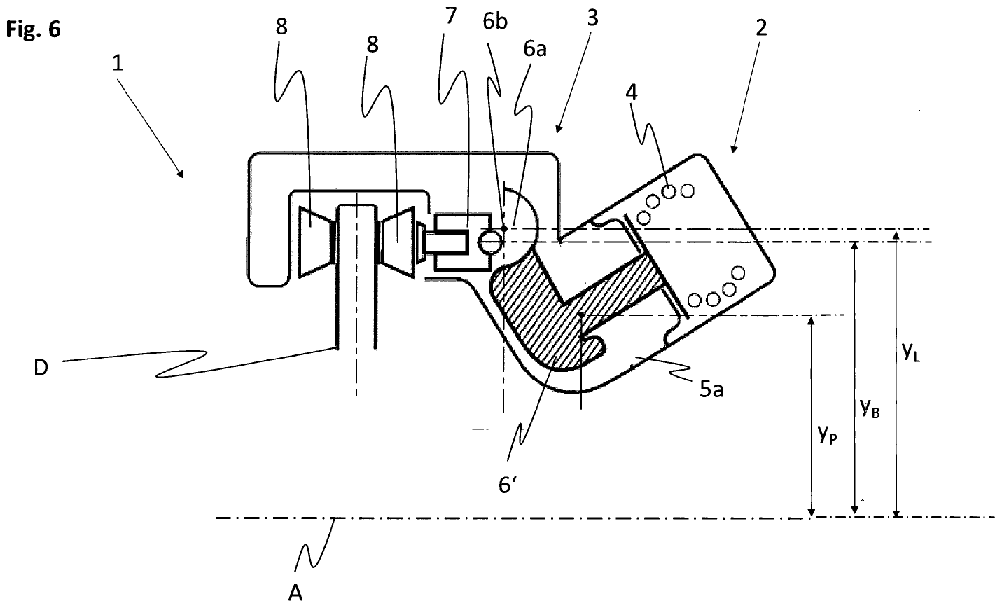

FIG. 6 shows a sixth embodiment of the present invention. The main difference compared to the fifth embodiment is that there is a combined lever 6, which fulfills the function of a push rod of the previous embodiments and the lever of the previous embodiments together.

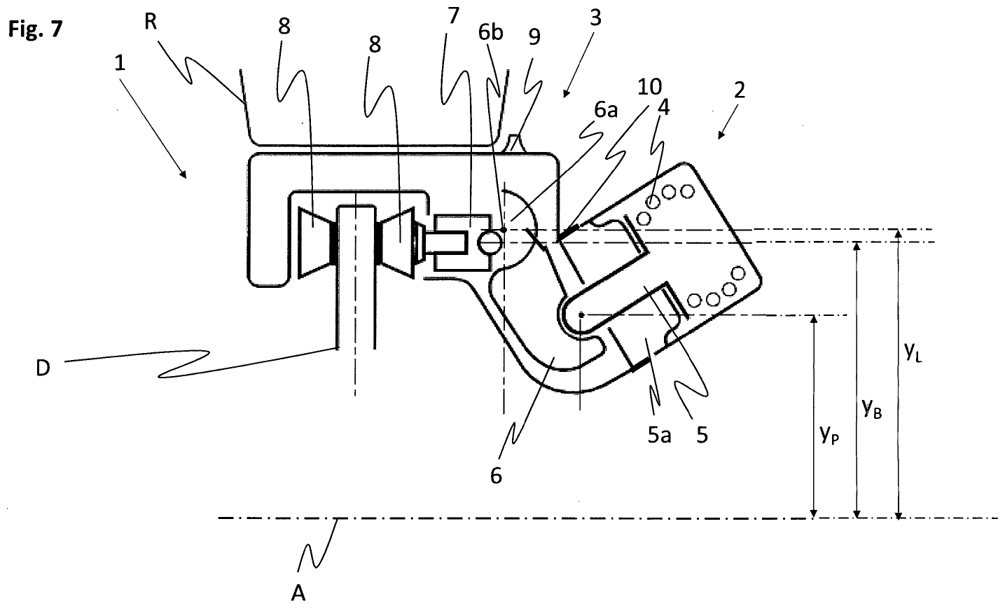

FIG. 7 shows a seventh embodiment of the present invention. Herein, the surface of the application unit 3 is very flat, and the arrangement of the whole park brake caliper 1 compared to a rim R of a wheel is shown. On the upper surface of the application unit 3, a hump 9 is provided. Such hump 9 can add additional stiffness to the caliper 1.

A high stiffness is always preferential, because it reduces the necessary clamping stroke in a caliper.

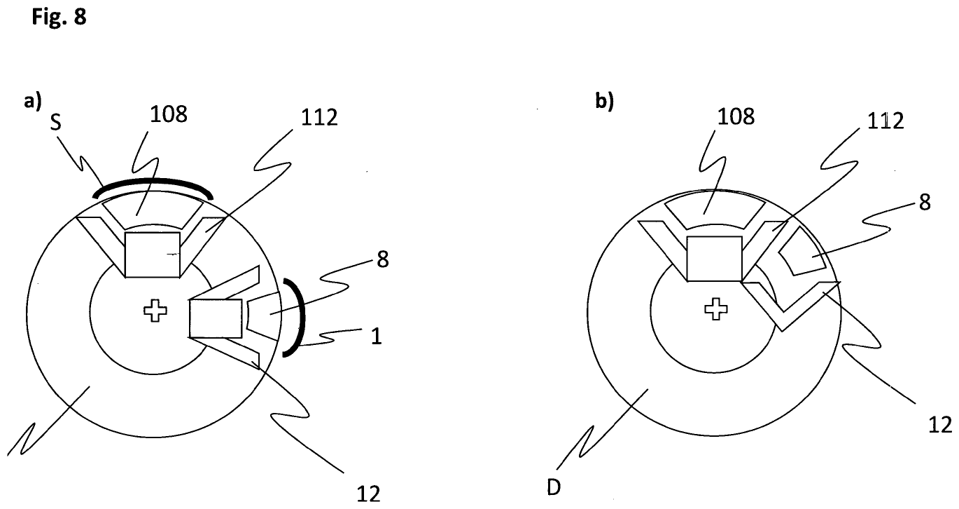

FIG. 8 shows two arrangements of a park brake carrier 12 with a respective brake pad 8 and a service brake carrier 112 with a respective brake pad 108 on a brake disc D.

In FIG. 8a), the park brake carrier 12 with respective brake pad 8 and the service brake carrier 112 with a respective brake pad 108 are radially separated around the brake disc D, the park brake carrier 12 being on the 3 o'clock-position and the service brake carrier 112 being at the 12 o'-clock position in this example. The park brake caliper 1 and the service brake caliper S are also separated.

In FIG. 8b), the park brake carrier 12 and the service brake carrier 112 are connected.

However, the brake pad 8 of the park brake and the brake pad 108 of the service brake are still radially separated. Calipers are not shown in this figure.

The present invention is not limited to the embodiments as described above.

It would also be possible that the lever 6 can have different shapes.

Furthermore, different springs 4 can be used, for example flat springs or coil springs.

Not only pneumatic actuation, but also hydraulic, magnetic or electromechanical actuation is possible.

### REFERENCE SIGN LIST

1 Park brake caliper
2 Actuation unit
2h Actuation unit housing
3 Application unit
3h Application unit housing
4 Spring
5, 5′ First push rod, second push rod
5a Chamber, additional chamber
6, 6′ Lever
6a Excenter
6b Pivot axis
7 Bridge
8 Brake pad (park brake)
9 Hump
10 Flange
11 Housing
12 Carrier (park brake)
108 Brake pad (Service brake)
112 Carrier (Service brake)
D Brake disc
A Axle
R Rim
S Service brake caliper

1.-17. (Canceled)

18. A park brake caliper for a utility vehicle, comprising:
an actuating unit configured to move a push rod, wherein the push rod is adapted to be pressed in one direction, but is adapted to be pressed in an opposite direction by an energy supply;
an application unit comprising a brake lever pivotably supported around a pivot axis and configured to rest at the push rod on one side and at a bridge on the other side via an excenter, wherein
the application unit is configured to be positioned around an axle of a utility vehicle,
the bridge is configured to press at least one brake pad against a brake disc of the utility vehicle, and
the lever points towards the axle in all positions.

19. The park brake caliper according to claim 18, wherein
the push rod is pre-tensioned, via a spring, in one direction in order to force the bridge to press the at least one brake pad against the brake disc of the utility vehicle, but is adapted to be pressed in the opposite direction by a pneumatic, hydraulic, electromechanical or magnetic force.

20. The park brake caliper according to claim 18, wherein
an axis of motion of the push rod of the actuating unit and the axle include an angle of between 10° and 80°.

21. The park brake caliper according to claim 18, wherein
an axis of motion of the push rod of the actuating unit and the axle include an angle of between 45° and 75°.

22. The park brake caliper according to claim 18, further comprising:
a second push rod accommodated in an additional chamber, wherein
the second push rod is adapted to transmit forces to the brake lever on the opposite side of the brake lever compared to the first push rod, and
the additional chamber is positioned on the opposite side of the brake lever compared to the first push rod.

23. The park brake caliper according to claim 22, wherein
the additional chamber is a pneumatic chamber.

24. The park brake caliper according to claim 18, wherein
a middle axis of the bridge is at a smaller distance from the axle than the pivot axis of the lever.

25. The park brake caliper according to claim 16, wherein
a joint between the push rod and the lever or an instantaneous center of rotation of the push rod and the lever is at a smaller distance to the axle compared to a plane of the bridge.

26. The park brake caliper according to claim 18, wherein
a middle axis of the bridge has a larger distance from the axle than the pivot axis of the lever.

27. The park brake caliper according to claim 18, wherein
the actuating unit has a housing and the application unit has a housing, and
the actuating unit is connected to the application unit through a flange, wherein said flange lies at least partially below the bridge plane.

28. The park brake caliper according to claim 18, wherein
a surface of the application unit is flat or curved, and
a hump is provided in an uppermost surface of the application unit.

29. The park brake caliper according to claim 18, wherein
the actuating unit and the application unit are disposed in a common housing.

30. The park brake caliper according to claim 18, wherein
the push rod and the lever are integrally formed in one combined member.

31. The park brake caliper according to claim 18, wherein
the caliper is of a floating type.

32. The park brake caliper according to claim 18, wherein
a carrier for brake pads is provided on the caliper.

33. The park brake caliper according to claim 18, wherein
brake pads are directly mounted to the caliper.

34. A brake system, comprising:
a park brake caliper according to claim 18; and
a service brake caliper,
wherein brake pads of the park brake caliper and the service brake caliper are radially spaced from each other.

35. The brake system according to claim 34, wherein
a friction pairing between park brake pads and the brake disc has a larger friction radius than a friction pairing between service brake pads and the brake disc.

36. The brake system according to claim 34, wherein
the brake pads of the park brake and the brake pads of the service brake are guided by a respective carrier, wherein the respective carriers are connected.
